(19) United States
(12) Patent Application Publication
(10) Pub. No.: US 2017/0221067 A1
(43) Pub. Date: Aug. 3, 2017

(54) SECURE ELECTRONIC TRANSACTION

(71) Applicant: INTERNATIONAL BUSINESS MACHINES CORPORATION, Armonk, NY (US)

(72) Inventors: Pablo F. Barquero Garro, Heredia (CR); Gregory J. Boss, Saginaw, MI (US); Luis C. Cruz Huertas, San Pedro (CR); Rick A. Hamilton, II, Charlottesville, VA (US); Franz F. Liebinger Portela, Heredia (CR); Edgar A. Zamora Duran, Heredia (CR)

(21) Appl. No.: 15/010,877

(22) Filed: Jan. 29, 2016

(51) Int. Cl. G06Q 20/40; G06Q 20/38

(52) U.S. Cl. CPC G06Q 20/40145; G06Q 20/382

(57) ABSTRACT

Computing systems, methods and tools for performing a secure electronic transaction between buyer and merchant. The transaction being able to be implemented without either party having to transmit confidential information between the parties of the transaction. The secure electronic transaction is mediated by a transaction system operating as part of a remotely accessible network or cloud computing environment. The buyer and the merchant register identifying information, payment information, shipping/billing information along with other confidential information to be stored by the transaction system prior to commencing the transaction. The buyer and merchant use assigned ID numbers or truncated versions thereof when transmitting transactional data and transactional approvals through the transaction system. Upon approval of the transactional terms by the buyer, the transaction system communicates operates to secure the transfer of funds from the buyer to the merchant without ever receiving, storing or being responsible for the security of confidential information.

### TECHNICAL FIELD

The present disclosure relates generally to computerized, systems and methods for implementing secure electronic transactions without exposing confidential information.

### BACKGROUND

Digital transactions involving a consumer paying with a credit card, debit card, bank account number through a digital transaction may be an impersonal transaction. Often, digital transactions are performed remotely, without the customer being required to be present. In the current digital age, identity theft and fraud have become common occurrences whereby unauthorized individuals gain access to a consumer's confidential information and perform digital transactions without the consumer's knowledge or consent.

The threat of identity theft and fraud impedes the growth of E-commerce. Security issues make consumers wary of making purchases through digital transfers that require confidential information to complete the transaction. The majority of instances of fraud originate from merchants who do not or cannot secure their databases from hackers and criminals. Many types of security measures have been attempted, including digital Secure Socket Layers, and “one-time use” disposable credit card numbers. These security measures deter fraud to a degree but do not solve issues of fraud, nor prevent them from occurring. Currently implemented security solutions do not fully protect confidential consumer information from being stolen from merchants, because current methods and systems still require the confidential information to be provided in order to transfer funds and complete the transaction.

### SUMMARY

A first embodiment of the present disclosure provides a method for performing a secure electronic transaction, said method comprising the steps of: requesting, by a computer processor, a connection to an electronic transaction system; receiving, by the computer processor, a graphical code from the transaction system, comprising transactional information, said transactional information identifies terms of the secure electronic transaction, wherein said transactional information excludes confidential information; displaying, by the computer processor, the transactional information; transmitting, by the computer processor, biometric authentication to the transaction system, approving the terms of the secure electronic transaction; further transmitting, by the computer processor, payment information to the transaction system for satisfying the terms of the secure electronic transaction, wherein the payment information excludes confidential information; and further receiving, by the computing processor, confirmation of a successful funds transfer from an issuing bank to a merchant account.

A second embodiment of the present disclosure provides a computer program product, comprising one or more computer readable hardware storage devices having computer readable program code stored therein, said program code containing instructions executable by the one or more computer processors to implement a method for performing a secure electronic transaction, said method comprising the steps of: requesting, by a computer processor, a connection to an electronic transaction system; receiving, by the computer processor, a graphical code from the transaction system, comprising transactional information, said transactional information identifies terms of the secure electronic transaction, wherein said transactional information excludes confidential information; displaying, by the computer processor, the transactional information; transmitting, by the computer processor, biometric authentication to the transaction system, approving the terms of the secure electronic transaction; further transmitting, by the computer processor, payment information to the transaction system for satisfying the terms of the secure electronic transaction, wherein the payment information excludes confidential information; and further receiving, by the computing processor, confirmation of a successful funds transfer from an issuing bank to a merchant account.

A third embodiment of the present disclosure provides a computer system, comprising one or more processors, one or more memories coupled to the one or more computer processors, and one or more computer readable storage devices coupled to the one or more processors, said one or more storage devices containing program code executable by the one or more processors via one or more memories to implement a method for performing a secure electronic transaction, said method comprising the steps of: requesting, by a computer processor, a connection to an electronic transaction system; receiving, by the computer processor, a graphical code from the transaction system, comprising transactional information, said transactional information identifies terms of the secure electronic transaction, wherein said transactional information excludes confidential information; displaying, by the computer processor, the transactional information; transmitting, by the computer processor, biometric authentication to the transaction system, approving the terms of the secure electronic transaction; further transmitting, by the computer processor, payment information to the transaction system for satisfying the terms of the secure electronic transaction, wherein the payment information excludes confidential information; and further receiving, by the computing processor, confirmation of a successful funds transfer from an issuing bank to a merchant account.

### BRIEF DESCRIPTION OF THE DRAWINGS

FIG. 1 depicts an embodiment of a computing network for implementing embodiments of the present invention.

FIG. 2 depicts a cloud computing network for implementing embodiments of the present invention.

FIG. 3 illustrates a flowchart describing an algorithm implementing embodiments of the present invention.

FIG. 4 depicts a flowchart illustrating an embodiment of a computing system network implementing embodiments of the present invention.

FIG. 5 depicts a flowchart visually depicting an embodiment of a computing system network implementing embodiments of the present invention.

FIG. 6 depicts an alternative embodiment of the flowchart of FIG. 6 depicting an alternative computing system network implementing embodiments of the present invention.

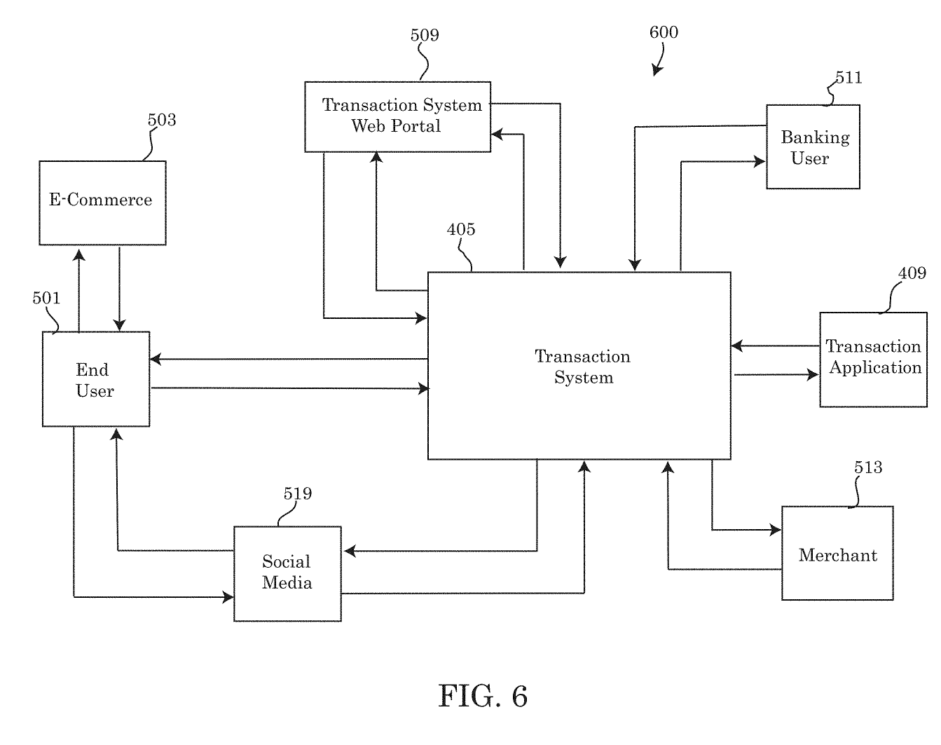

FIG. 7 depicts an embodiment of the architecture of a computing system network implementing embodiments of the current invention.

FIG. 8 illustrates an embodiment of a computer system used for implementing tools, methods and systems for designing and executing large scale workforce policies in geographically dispersed labor markets in accordance with embodiments of the present invention.

### DETAILED DESCRIPTION

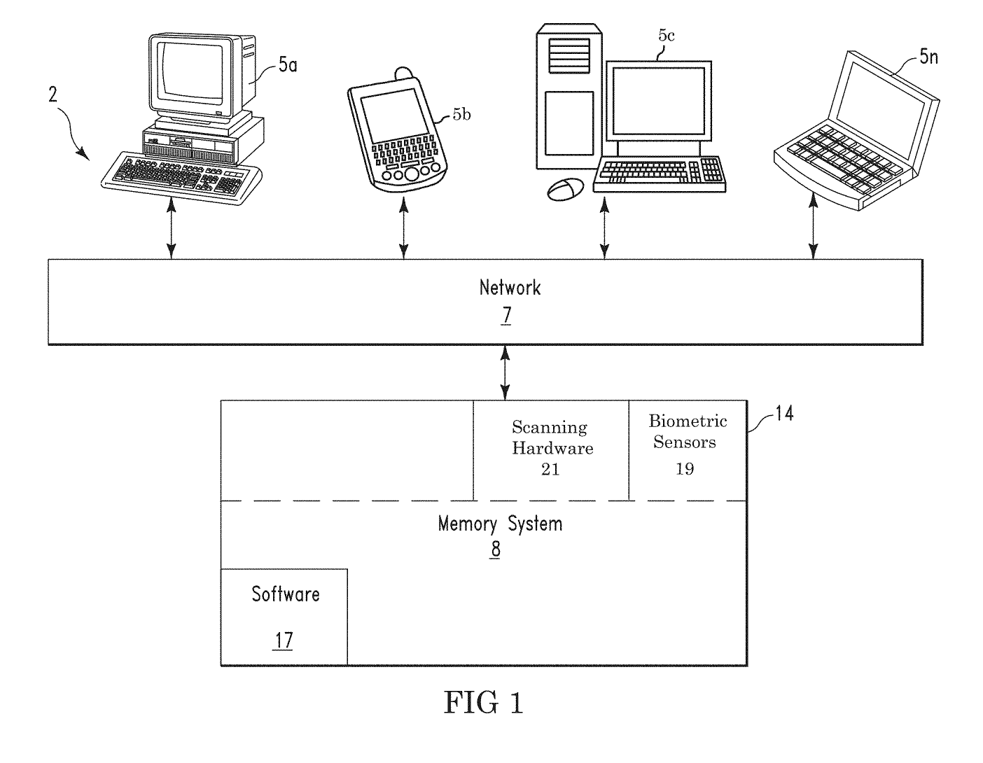

Referring to the drawings, FIG. 1 is a depiction of an embodiment of a computing network for performing a secure electronic transaction without including confidential information. The embodiments of the electronic transaction system may include one or more nodes 5a . . . 5n connected through a network 7 to a computing system 14. There are not any limitations of the number of nodes that may be connected to the network 7, rather nodes 5a, 5b, 5c . . . 5n are meant to demonstrate that a plurality of one or more nodes may be connected to the network 7. Network 7 may include any type of network including, inter alia, a local area network, (LAN), a wide area network (WAN), the Internet, a wireless network, etc. Nodes 5a . . . 5n may include any type of computing system(s) including, inter alia, a computer (PC), a laptop computer, a tablet computer, a server, a PDA, a smart phone, etc. Computing system 14 depicts more specifically, the hardware and software components that may encompass a node. The computer system 14 may be any type of computing system(s) including, inter alia, a desktop computer (PC), a laptop computer, a tablet computer, a server, mainframe etc. Computing system 14 includes a memory system 8. Memory system 8 may include a single memory system. Alternatively, memory system 8 may include a plurality of memory systems. Memory system 8 includes software 17 comprising computer programming code for electronic transaction tools implementing methods for performing a secure electronic transaction using the electronic transaction system.

In some embodiments, the nodes and/or computing system 14 may include additional specialized hardware to perform the secure electronic transaction. In some embodiments, the computing system and/or nodes of the network may include biometric sensors 19 and/or scanning hardware 21. The biometric sensors 19 may be used for transaction authentication purposes, for example, to verify users of the nodes on the computing network providing transaction authorization. The biometric sensors 19 may include fingerprint readers, voice recognition microphones/voice recognition software loaded in the memory of the computing system/node, retina scanners, and biometric cameras. In other embodiments, additional scanning hardware 21 may be provided as part of the electronic transaction system. The scanning hardware 21 may be used to decode information and data, relating to the electronic transaction, provided to the user in one or more graphical formats, including barcodes and QR codes. Scanning hardware 21 may include barcode scanners and QR code scanners capable of decoding information from ITF codes, Code 93, CODABAR, GS1 DATABAR, MSI Plessey barcodes, 2D barcodes, QR codes, data matrix codes, PDF417 or Aztec barcodes, or any other graphically encoded format known in the art.

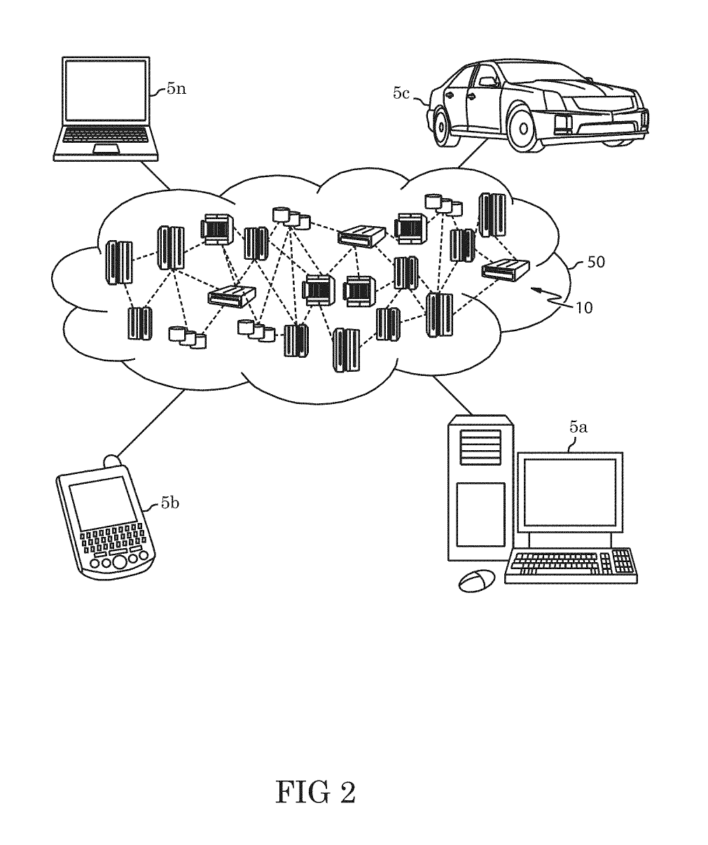

In some embodiments, the computer network 7 may be a cloud computing network operating under a cloud computing environment 50, as shown in FIG. 2. Cloud computing may be referred to as a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Embodiments of a cloud computing model may include one or more of at least five characteristics, at least three service models, and at least four deployment models.

Characteristics of a cloud computing environment may include on-demand self-service, broad network access, resource pooling, rapid elasticity and measured service. The term “on-demand self-service” may refer to a characteristic of a cloud computing environment that may allow a tenant of the cloud environment to unilaterally provision computing capabilities, such as server time and network storage, as needed, automatically without requiring human interaction with the owner of the cloud environment.

“Broad network access” may refer to the capabilities available over the network which may be accessed through standard mechanisms that promote use by heterogeneous thin or thick client platforms (e.g., mobile phones, laptops, and PDAs).

“Resource pooling” may refer to the tenant's computing resources being pooled to serve multiple tenants using a multi-tenant model, with different physical and virtual resources dynamically assigned and reassigned according to demand. There is a sense of location independence in that the tenant may generally have no control or knowledge over the exact location of the provided resources but may be able to specify location at a higher level of abstraction (e.g., country, state, or datacenter).

“Rapid elasticity” refers to capabilities of the cloud network to rapidly and elastically provision, in some cases automatically, to quickly scale out and rapidly released to quickly scale in. To the tenant, the capabilities available for provisioning may appear to be unlimited and can be purchased in any quantity at any time.

“Measured service” may refer to cloud systems being able automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The service models for a cloud computing environment may include Software as a Service (SaaS), Platform as a Service (PaaS) and Infrastructure as a Service (IaaS). Software as a Service (SaaS) refers to the capability provided to the tenant to use the service provider's applications running on a cloud infrastructure. The applications are accessible from various client devices through a thin client interface such as a web browser (e.g., web-based e-mail). The tenant does not manage or control the underlying cloud infrastructure including network, servers, operating systems, storage, or even individual application capabilities, with the possible exception of limited user-specific application configuration settings.

Platform as a Service (PaaS) refers to the capability provided to the consumer to deploy onto the cloud infrastructure tenant-created or acquired applications created using programming languages and tools supported by one or more service providers. The tenant does not manage or control the underlying cloud infrastructure including networks, servers, operating systems, or storage, but has control over the deployed applications and possibly application hosting environment configurations. In contrast, Infrastructure as a Service (IaaS) refers to the capability provided to the tenant to provision processing, storage, networks, and other fundamental computing resources where the consumer is able to deploy and run arbitrary software, which can include operating systems and applications. The tenant does not manage or control the underlying cloud infrastructure but has control over operating systems, storage, deployed applications, and possibly limited control of select networking components (e.g., host firewalls).

Deployment models of a cloud computing environment such as the one depicted in FIG. 2 may include a private cloud, community cloud, public cloud or hybrid cloud. A “private cloud” refers to cloud infrastructure that is operated solely for an organization. It may be managed by the organization or a third party and may exist on-premises or off-premises. A “community cloud” may refer to cloud infrastructure is shared by several organizations and supports a specific community that has shared concerns (e.g., mission, security requirements, policy, and compliance considerations). It may be managed by the organizations or a third party and may exist on-premises or off-premises.

A “public cloud” deployment model may refer to cloud infrastructure that is made available to the general public or a large industry group and is owned by an organization selling cloud services to one or more tenants. A “hybrid cloud” may refer to cloud infrastructure that is a composition of two or more clouds (private, community, or public) that remain unique entities but are bound together by standardized or proprietary technology that enables data and application portability (e.g., cloud bursting for load-balancing between clouds).

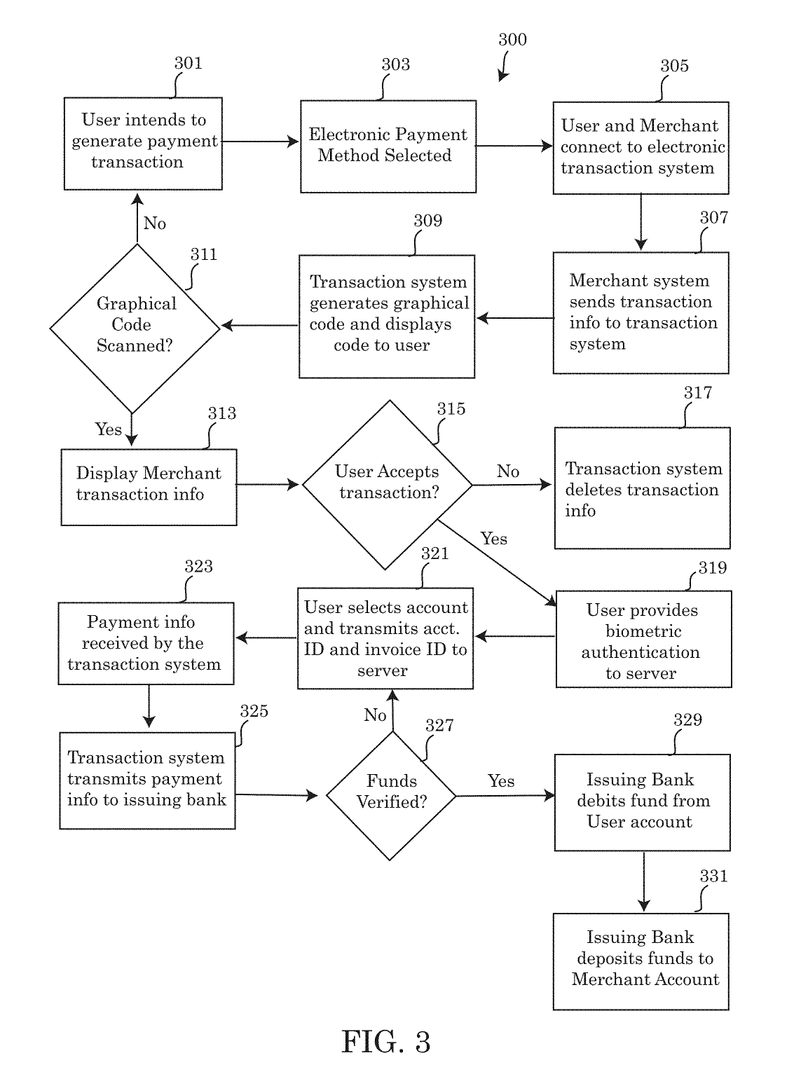

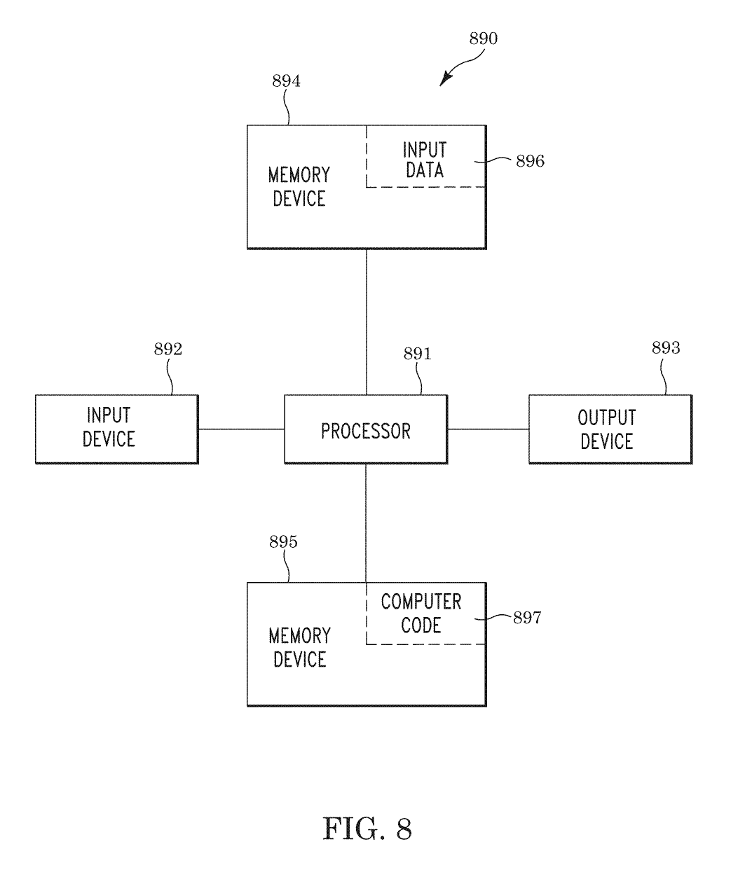

A cloud computing environment may be considered service oriented with a focus on statelessness, low coupling, modularity, and semantic interoperability. At the heart of cloud computing environment may be an infrastructure comprising a network of interconnected nodes. Referring now to FIG. 3, illustrating an embodiment of a cloud computing environment 50, the cloud computing environment 50 may comprise one or more cloud computing nodes 10 with which local computing devices used by cloud tenants and/or services providers connected to the cloud computing environment. The computing nodes 10 may include for example, desktop computer 5a, personal digital assistant (PDA) or cellular telephone 5b, automobile computer system 5c, and/or laptop computer 5n. Nodes 10 may communicate with one another. They may be grouped (not shown) physically or virtually, in one or more networks, such as Private, Community, Public, or Hybrid cloud environment as described hereinabove, or a combination thereof. This allows cloud computing environment 50 to offer infrastructure, platforms and/or software as services for which a cloud consumer does not need to maintain resources on a local computing device. It is understood that the types of computing devices 5a-n shown in FIG. 2 is intended to be illustrative only and that computing nodes 10 and cloud computing environment 50 can communicate with any type of computerized device, such as the computer system depicted in FIG. 8 (described below), over any type of network and/or network addressable connection (e.g., using a web browser).

Embodiments of the cloud computing environment 50 may include both hardware and software layers having hardware and software components. Examples of hardware components may include mainframes; RISC (Reduced Instruction Set Computer) architecture based servers; servers; blade servers; storage devices; and networks and various networking components known to those in the art. In some embodiments, software components include network application server software and database software.

In some embodiments, the cloud computing environment may include a virtualization layer providing an abstraction layer from which the following examples of virtual entities may be provided, including virtual servers; virtual storage; virtual networks, including virtual private networks; virtual applications and operating systems; and virtual clients.

Moreover, embodiments of the cloud computing environment may further include a management layer, which may provide resource provisioning that dynamically procures computing resources and other resources that are utilized to perform tasks within the cloud computing environment. The management layer may further include a user portal providing access to the cloud computing environment for consumers and system administrators and service level management providing cloud computing resource allocation and management such that required service levels are met. Service Level Agreement (SLA) planning and fulfillment of the cloud computing environment may provide pre-arrangement for, and procurement of, cloud computing resources for which a future requirement is anticipated in accordance with an SLA. an identity verification may verify the permission granted to customers and/or service providers to access to network based resources and perform tasks in the cloud based environment 50.

Referring now to FIG. 3, depicting an algorithm 300 for performing a secured electronic transaction. The algorithm may be initiated by an end user, which may also be referred to interchangeably as a buyer or purchaser. In step 301 of the algorithm, the end user may intend to generate an electronic transaction requiring the exchange of a payment or authorization to complete the complete the transaction. The intent to generate the transaction may arise through the user's use of a computing system connected as node to the computing network 7, 50. Computing systems capable of initiating an electronic transaction may include a mobile computing device, tablet computer, smartphone or cellular telephone, desktop computer, laptop computer, network enabled media player, payment kiosk, cash register or any other computing device. The end user may be making a purchase remotely from their computing device, wherein the user does not interact with the seller or merchant directly, such as through an online or Internet based purchase using a website or web based application. The end user may indicate the user's intent to engage in a secure electronic transaction by “checking out” or signaling to a merchant, that the user is ready to engage in an electronic transaction with the merchant to transfer the ownership of goods and services to the end user in exchange for payment. In alternative embodiments, the user may be intending to generate a payment transaction in a physical store location by interacting with a merchant or an agent of the merchant (such as a cashier) face to face, by initiating the transaction electronically through a payment kiosk, or other computing device capable of processing payment located within the physical retail store.

After the end user indicates to the seller or merchant the user's intent to engage in an electronic transaction, in step 303, the user may select an electronic payment method corresponding to the systems, methods and tools of the current application, capable of performing a secure electronic transaction. For instance, in some embodiments, the user may select a particular program or application loaded in the memory of the user's computing system. In other embodiments, the application or program for performing the transaction may be accessible using a thin client such as a web browser to access a web based electronic transaction application or web portal, while in other embodiments, the application or program for performing the secured electronic transaction may be loaded into a specialized machine or hardware for processing the transaction, such as a payment kiosk loaded with the electronic transaction tools as a ROM or firmware.

In step 305, the end user (acting as the buyer) and the merchant may connect to a transaction system on the computing network. The buyer and the merchant may request connection to the transaction system using a locally stored electronic payment application or program, a network accessible application or program or web based application or service via a browser or web portal. In some embodiments, the buyer and merchant may register login credentials with the transaction system and identifying information about the buyer and the merchant. The identifying information tied to the login credentials of both the buyer and merchant may include information tying buyer and merchant to specifically registered accounts maintained or hosted by the transaction system. For instance, the buyer and merchant may each maintain and store information identifying specific accounts, payment methods (such as credit card numbers, bank accounts and digital currency accounts), authorized user names, shipping addresses, identification numbers or non-confidential information that may be used for completing the electronic transaction.

In some embodiments, the transaction system performing the electronic transaction between buyer and merchant may be accessible via a local area network (LAN), personal area network (PAN), wide area network (WAN), storage area network, enterprise private network (EPN), virtual private network (VPN), mobile communications network or a cloud computing network, such as the cloud network described in FIG. 2 above. Upon connecting to the transaction system in step 305, the merchant system in step 307 may generate informational data, referred to as transactional information, describing the electronic transaction between the buyer and the merchant. The transactional information may transmitted to the transaction system by the merchant and the content of the transactional information may include an invoice identification number (which may be used by the merchant and buyer for identifying the parameters of the electronic transaction), a truncated buyer identification or account number, the names of the products or services being sold, the quantity of products, the price and a truncated merchant identification number.

The truncated buyer identification number and merchant identification number may be series of numbers or alphanumerics, which is shorter in length than the full length of the buyer ID number or merchant ID number stored on the transaction system. For example, the ID number for the buyer or merchant may be 16-20 characters in length, however the transaction system and other parties involved in the electronic transaction may be able to identify the buyer or merchant from an ID number that only contains the last four or five digits of the ID numbers. The truncated identification numbers of both the buyer and merchant allow for the transaction system to identify the parties involved, without having to risk compromising the full identification number. The transaction information cannot be considered to contain confidential information or sensitive information because if the transactional information was intercepted or stolen by an unintended 3^{rd} party the information contained in the transactional information data would not benefit the unintended 3^{rd} party and would not allow for the 3^{rd} party to identify either the buyer or merchant accounts stored on the transaction system using only the truncated ID numbers.

The transaction system receiving the transmission of the transactional information from the merchant system may store the transactional information in a memory or storage device of the transaction system, or one or more computing systems acting as shared resources connected in a cloud network 50 connected to the transaction system. Subsequently, in step 309, the transaction system may convert the transactional information received from the merchant system as data, into a graphical code encoding the details of the electronic transaction. The transaction information encoded by the graphical code may include, but is not limited to any non-confidential information that identifies the nature of the electronic transaction to the buyer, merchant and transaction system, including for example, an invoice identification number, product name(s) or product identification number(s), product quantities, product prices, total price of the transaction and/or a truncated merchant id number. The inclusion of the truncated merchant id number identifies to the transaction system which merchant registered on the server is acting as the merchant, while the inclusion of the truncated buyer identification number identifies to the transaction system which registered user of the transaction system and electronic transaction application should be receiving the graphical code. Moreover, the non-confidential information stored and transmitted in the form of the graphical code allows for the transaction system to facilitate transfers of payment between the buyer, seller and respective banking institutions, without having to electronically transmit banking, credit card or other payment information between the buyer and seller, thus avoiding the possibility of the confidential information be intercepted or swiped by unwanted 3^{rd} parties having access to unsecured computing systems maintained by either the buyer or seller.

The graphical code generated in step 309 may be any type of graphics based code known in the art, that is capable of encoding and storing information that may later be recalled once scanned or decoded by the recipient. Examples of graphics based codes may include ITF codes, Code 93, CODABAR, GS1 DATABAR, MSI Plessey barcodes, 2D barcodes, QR codes, data matrix codes, PDF417, Aztec barcodes or any other bar coding format known in the art. The transaction system may transmit the graphical code generated in step 309 to the buyer's computing system. The computing system of the buyer, receiving the graphical code, may alert the buyer via sound or visual notification in some embodiments. In other embodiments, the graphical code may be submitted to the buyer via a messaging service such as email, SMS or a messaging service integrated into the electronic transaction tools or cloud network. In the exemplary embodiments, the electronic transaction tools may visually display the graphical code on a computing system operated by the buyer. In alternative embodiments the electronic transaction tools may display a brief message describing the source of the generated graphical code and a request for the buyer to scan or decode the graphical code to display the information relating to the electronic transaction.

In step 311, a determination may be made whether or not the buyer has scanned the graphical code and displayed the transactional information encoded by the graphical code transmitted by the transaction system. The graphical code may be scanned by one or more specialized hardware components connected to the buyer's computing system, wherein the computing system may have specialized circuitry for reading graphical codes. The scanning hardware 21 and corresponding software capable of decoding the information presented in the graphical code may be integrated with the hardware of computing system or as part of an electronic transaction tool loaded in the memory of the computing system. In other embodiments, a separate computing system may display the graphical code while a computing system equipped with the scanning hardware 21 scans, decodes and displays the transactional information. The scanning hardware 21 may be any hardware capable of decoding barcodes, QR codes or any other graphical code described herein or known in the art, including specialized barcode scanners and camera systems.

If, the electronic transaction tools makes the determination in step 311 that the graphical code has not been scanned by the buyer's computing system, the electronic transaction may not be completed, and neither payment nor the exchange of goods and services may be performed. In some embodiments, the display and validity of the graphical code provided to the buyer may have a limited length of time wherein it may be scanned for the purposes of proceeding with the electronic transaction. If, the buyer does not scan and acknowledge the graphical code within the pre-determined amount of time, the transaction system may cancel the electronic transaction; delete the transaction, graphical code and/or transactional information from the memory of the transaction system. A buyer who has not scanned the code within the allotted time period may restart the electronic transaction by re-performing steps 301, 303 and 305. In some embodiments, the transaction system may re-activate the previously timed out graphical code and re-transmit the code to the buyer. In alternative embodiments, the transaction system may generate a new graphical code having a different invoice id number associated with the transactional information to the computing system operated by the buyer.

If a determination is made by the electronic transaction tools in step 311, that the graphical code being displayed to the buyer has been scanned, the scanned code in step 313 may display the transactional information to the buyer via the display hardware of the buyer's computing system. The transactional information displayed to the buyer may include the invoice id number, the products or services being purchased, the quantity of the products, the total price of the transaction and the truncated merchant identification number identifying the merchant that the buyer is interacting with for the transaction and the truncated buyer identification number, identifying the buyer as the other intended party to the transaction. Upon scanning the graphical code, the information displayed by the electronic transaction tools may further include a request for confirmation or authorization in step 315 to proceed with completing (closing) the electronic transaction.

In addition to providing an added security layer by using the buyer to confirm the transaction at multiple points, the inclusion of step 315 offers a unique security feature over other transaction methods known in the art, relying on the buyer to engage in the closing of the transaction, instead of the seller. Under previous systems, such as credit card readers found in retail stores, or online payments systems used for online websites, it is the seller collecting confidential payment information from the buyer and closing the sale by transmitting the information via the seller's computing system to a credit card processing server, payment processing company or the issuing banks. However, under the disclosed method, system and tools, the buyer is acting as the intermediary between the merchant and transaction system processing the payment. Although the transaction system is pre-supplied with the registration information of both the buyer and the merchant, at no point in time, does the buyer pass along or provide the seller with any confidential information. By performing the transaction without providing the seller with the information directly, the risk of confidential information being stolen at the point of sale, such as through insecure payment databases maintained by a merchant, is prevented. Neither the merchant nor the buyer ever receive confidential information about the other party to the electronic transaction, nor is either party responsible for maintaining or securing the confidential information of the parties to the transaction. The information shared between buyer and merchant is not confidential and truncated variations of confidential information. Any confidential information necessary for completing the transaction is secured by the transaction system and never passed between buyer and merchant.

In step 315 of the described method, the electronic transaction tools determine whether or not the buyer accepts the transaction terms displayed to the buyer in step 313. If, the buyer declines the terms displayed in step 313, the buyer transmits the notice of the decision to decline transactional terms to the transaction system. In response to the receipt of the notice of decline, in step 317, the transaction system deletes the transactional information from the transaction system's memory, thus ending the proposed transaction between the buyer and merchant. Subsequently, in some embodiments, the transaction system may transmit notice of the buyer's decision to decline the transaction to the merchant.

If, the buyer accepts the terms presented in the transactional information displayed in step 313, the buyer may perform an affirmative action signaling to the transaction system to proceed with the transaction. The action by the buyer may a simple action such as clicking “agree” or sending a request to the transaction system to proceed with the transaction. In the exemplary embodiment, the affirmative action provided to the transaction system signaling the transaction system to proceed with performing the transaction in accordance with the terms displayed in step 313, may include providing biometric information to the transaction system. As shown in step 319 of FIG. 3, the user may provide biometric information to the transaction system to properly authenticate to the transaction system, the acceptance of the terms and further positively demonstrate that the actual buyer is the individual authorizing the transaction to commence.

The biometric information provided to the transaction system may be any type of biometric data. The types of biometric data provided may include a scan of the buyer's fingerprint, a scan of the buyer's retina or iris, a facial scan or a voice imprint. To provide the biometric data to the transaction system, the buyer may input the biometric data using one or more pieces of specialized biometric sensors 19, hardware and accompanying software to collect the biometric input. Examples of the specialized hardware connected to the computing system of the buyer may include fingerprint scanners, retina or iris scanners, cameras which may be programmed with facial recognition software, and microphones for receiving voice data. The biometric data collected at the time of the authentication of the transaction may be transmitted to the transaction system and compared with biometric data previously collected and stored by the transaction system. For example, at the time the buyer requested login credentials to the transaction system and registered buyer information with the transaction system, the buyer may also provide biometric data to the transaction system for the authentication purposes of step 319.

Once the transaction system receives and confirms the biometric data authorizing the electronic transaction, the electronic transaction tools may further request from the buyer payment information. In step 321, the buyer may provide the payment information to the transaction system by selecting an account from which payment will be made to the merchant, and transmitting the account information and invoice ID or other transactional information to the transaction system. The payment information, including the account information may be pre-registered with the transaction system to reduce and eliminate the amount of confidential information exchanged between the buyer and the transaction system. Accordingly, a banking account, credit card number or other payment information may not need to be sent to the transaction system. Rather, a truncated form of the payment information and account numbers may be transmitted, indicating to the transaction system which payment method is desired by the buyer for completing the purchase. The full details of the payment accounts are not transmitted at the time of closing the transaction, rather the account information and payment information is matched to the transmitted truncated form. An unwanted third party intercepting the transmissions between the buyer and the transaction system would be unable to identify payment method, banking account number or credit card number through the interception of only the truncated form, without further details being known to the third party.

In step 323, the payment information selected by the buyer and transmitted to the transaction system is received. Upon the receipt of the payment in step 323, the transaction system may establish a connection with a computing system or computing network of the issuing bank to negotiate the closing of the electronic transaction using the payment method being provided by the buyer in step 321. After establishing a connection with the processing system of the issuing bank, the transaction system, in step 325, may transmit the payment information to the issuing bank. The payment information may include identification of the parties involved in the transaction, payment amount, account numbers of the buyer from which payment is being transferred from and the account numbers of the merchant receiving the payment from the buyer.

In step 327, the issuing bank's server, computing system or computing network may verify whether or not the buyer's account provided by the transaction system has available funds to transfer to the merchant or seller's account. If, in step 327, the issuing bank is unable to complete the electronic transaction due to insufficient funds, the issuing bank may transmit a notification request back to the transaction system requesting updated payment information bearing account information that has funds available to complete the transaction. Upon receipt of the declined payment information, the transaction system may transmit a request to the buyer to provide updated payment information and re-transmit the payment information to the transaction system in a manner similar to step 321, 323 and 325 of the method described in FIG. 3.

If, the funds are verified by the issuing bank in step 327 and the funds are determined to be sufficient for completing the electronic transaction between the buyer and merchant, the issuing bank of the buyer may proceed to debit the amount of money required by the transaction in step 329, in accordance with the transactional information provided by the merchant in step 307, displayed to the buyer in step 313 and approved by the buyer in step 319 and then subsequently request the deposit of the funds in step 331 into the merchant account on file with the transaction system when the merchant registered the merchant's credentials with the transaction system. Thus completing the electronic transaction between the buyer and merchant. In some embodiments, upon the completion of the transaction, the transaction system may transmit a notification to the buyer and the merchant that the transaction has been completed.

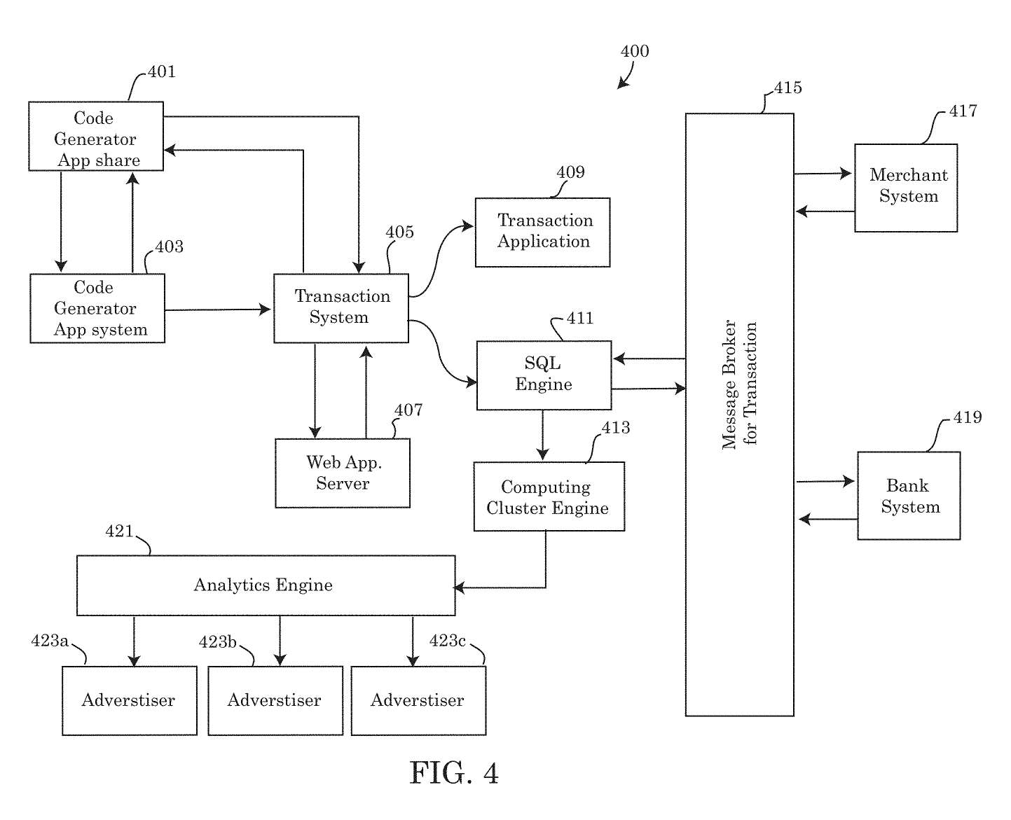

Referring to the drawings, FIG. 4 depicts a flowchart illustrating architecture of an embodiment of an electronic transaction computing network system 400 implementing embodiments of the secure electronic transactions described above. The embodiments of the computing network system 400 may include a transaction system 405. In some embodiments of the network 400, the transaction system 405 may act as the central computing system or node of the computing network or cloud computing network facilitating the secure electronic transaction between the buyer and the merchant. Embodiments of the transaction system 405 may be a server, RISC architecture based servers, blade servers or mainframe. In alternative embodiments, the transaction system 405 may be a virtual computing system, such as a virtual server allocated resources on a physical network, virtual network or cloud network.

Embodiments of the transaction system 405 may send and receive requests and transmit data to the merchant, buyer and banking institutions connected to the transaction system on the computing network 400. In some embodiments, the merchant, buyer and banking institutions may establish their connection to the transaction system 405 through a web application server 407 hosting a web application or computer program establishing a connection to the transaction system and the nodes of network 400 for initiating, commencing and completing the secured electronic transaction. For example, the buyer and merchant may connect to the transaction system 405 facilitating the electronic transaction using a website hosted by the web application server 407, a program or app containing program code directing the buyer or merchant to the transaction server or a computing system having specifically designed hardware having pre-programmed firmware, bios or read-only memory (ROM) containing program code establishing connection with the transaction system 405 with the purpose of performing a secured electronic transaction.

In one embodiment, a buyer and merchant may access the transaction system 405 via the web application server by logging into a website containing a web application program or client connecting the buyer or merchant to the network 400 hosted by the transaction system 405. In other embodiments, the buyer or merchant may connect to the transaction system 405 through a dedicated piece of hardware loaded with programmable instructions specifically for performing the electronic transaction. In this example, the hardware may be a cash register, payment kiosk or payment processing machine. However, instead of the user providing the payment information directly to the merchant, the buyer may use the dedicated hardware to log into their previously registered account via the transaction system 405 storing the user's confidential information. Accordingly, the cash register, payment processing machine or payment kiosk located in the merchant's store does not have access to the confidential information of the buyer, rather the cash register, kiosk and payment processor merely connect to the transaction system and forward the transactional information as described above.

In some embodiments of the transaction computing network 400, the transaction system 405 may connect to a graphic code generator application 401 and/or a graphic code generator application server 403 for the purpose of encoding the transactional information into a graphical code, as described above for step 309. In one embodiment, the transaction system may have a graphical code generating application 401 locally stored as program code in the memory of the transaction system 405. In other embodiments, the graphical code application 401 may be remotely accessible via a network connection to the transaction system 405. In certain embodiments, the graphical code generating application may be stored on a graphical code generating server 403 or other computing system on the electronic transaction network 400. The graphical code generating application server 403 may receive requests from the transaction system 405 to generate a graphical code associated with a particular electronic transaction, such as described in step 309 above, and the code generating server 403 may generate the graphical code using the graphical code generating application 401 and subsequently transmit the graphical code data back to the transaction system 405.

For example, the transaction system 405, upon receiving transactional information from a merchant system 417 via the web application server 407, the transaction system may request the graphical code generator application 401 direct generates a graphical code, encoding the transaction information, as described above in step 309 or indirectly through the graphical code generator server 403 storing the code generating application 401. Embodiments of the transactional system 405, upon receipt of transactional information from a merchant, may transmit a request to the graphical code generator application 401 to encode the transactional data as a graphics based code, such as a bar code or QR code.

In the exemplary embodiment of FIG. 4, the transaction system 405 may communicate with the buyer's computing system via an electronic transaction application 409 loaded on the computing system of the buyer. The electronic transaction application 409 may be an electronic transaction tool, which may include an interface loaded on the buyer's computing system or node of electronic transaction network 400. For example, the transaction application 409 may be a mobile computing system, desktop, laptop, dedicated hardware loaded with the electronic transaction tools such as a payment kiosk, etc. Embodiments of the transaction system 405 may transmit the graphical code received from the graphical code generating application 401, encoding the transactional information, to the transaction application 409, whereby the buyer may scan and display the transactional information as described above in steps 311, 313 and 315.

In some embodiments of the electronic transaction network 400, the transaction system 405 of the network, or one or more computing systems connected to the network may include an SQL engine 411. The SQL engine 411 may be any database engine capable of storing, processing and securing transactional data relating to the secure electronic transaction, the buyer and merchant information including payment information and buyer or merchant ID numbers. The SQL engine may create relational databases for the processing of the electronic transactions as well as perform analytical processing of the electronic transaction data. Functions of the SQL engine 411 may include creating tables for storing electronic transactional data, buyer and seller information and database objects such as indexes, and stored procedures for viewing, managing or securing the electronic transaction data and transactional information.

In some embodiments, the SQL engine may be a “Big SQL” that is able to handle large quantities of transactional data. Embodiments of Big SQL may include a combination of an SQL interface that may allow for adhoc processing of data as well as parallel processing which compensates for large amounts of transaction data and user information being received. In some embodiments, the processing of large quantities of data may be accomplished using the Big SQL engine in combination with a computing cluster engine 413, such as a Hadoop cluster engine. When used in combination with a computing cluster engine 413, such as the Hadoop cluster engine. In some embodiments, the Big SQL or other SQL engine 411 may be deployed directly on the physical Hadoop Distributed File System cluster. The SQL engine may push the processing down to the nodes of the computing cluster that hold the transaction data, decreasing the latency of the parallel processing performed by the SQL engine.

Embodiments of the computing network 400 implementing the secure electronic transaction may further include a message broker 415 application installed on the network 400. The message broker 415 may be an intermediary program module capable of translating messages between computing systems connected to the transactional network 400, including the merchant system 417, the bank system 419 responsible for processing the transfer payment from the buyer account to the merchant account in steps 325, 327, 329 and 331, web server 407, the graphical code generator system 403 and the buyers computing system loaded with the transaction application 409. The message broker 415 may be installed as part of the transaction system 405 or may be installed on a separate computing system in communication with the SQL engine 411 of the transaction system 405 on the transactional network 400. Embodiments of the message broker 415 may be responsible for validating, transforming and routing messages to one or more destinations of the transaction network 400 or to distribute messages and communications across different operating systems and networks. The message broker 415 may be responsible for mediating communication between applications/web services, for example, messages between sent and received by the transactional application 409 operating on the buyer's computing system, the merchant system's payment processing applications/websites and the secured banking applications of the banking system 419.

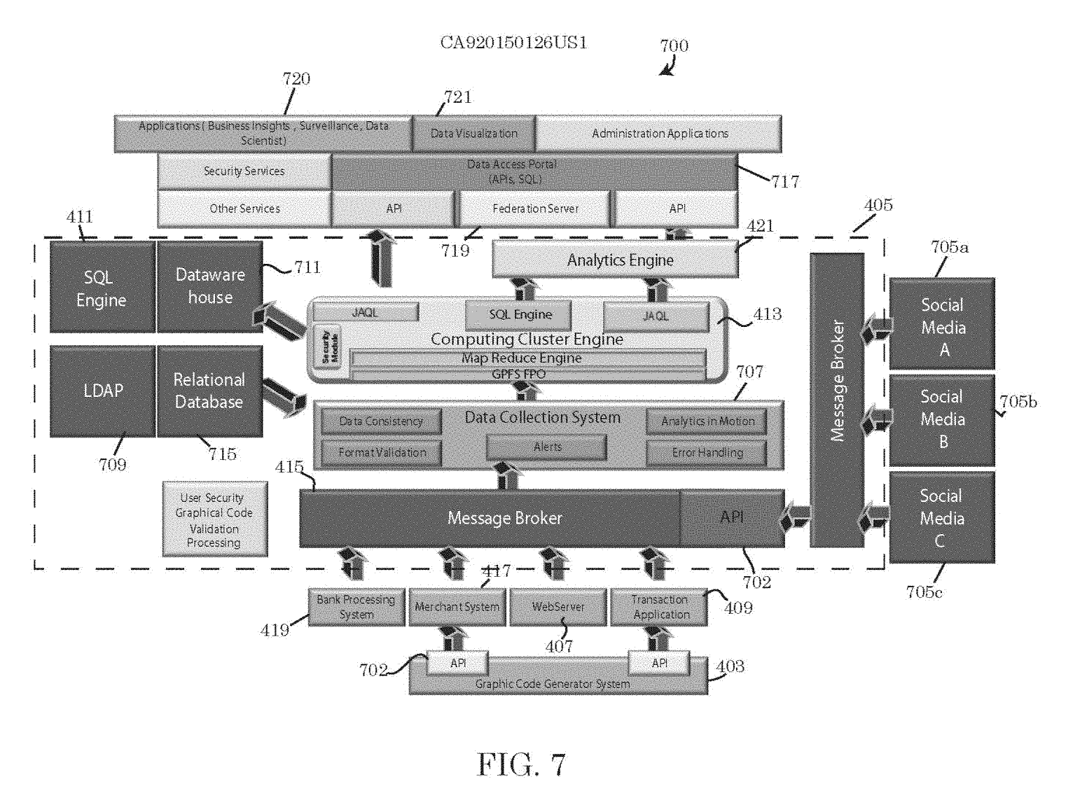

In some embodiments of the transaction network 400, the SQL engine 411 and the computer cluster engine 413 may function in tandem with analytics engine 421 to perform data analytics on the transactional data and other information being processed, transmitted and stored by the SQL Engine 411. In some embodiments, the computing cluster engine 413 and the analytics engine 421, may be combined as part of the same engine and/or system as an integrated data analytics solution. For example, the analytics engine 421, computer cluster engine 413 and SQL engine 411 may each be loaded as programs into the transaction system 405, as shown in the embodiment of FIG. 7, described below. In alternative embodiments, the computing cluster engine 413 and analytics engine 421 may be separate computing engines that may operate together to perform data analytics on the data stored by the SQL engine, but separately loaded on different nodes of the computing network 400.

The term data analytics may refer to a process of examining the data stored by the SQL engine and processed by the computing cluster engine 413 and/or the analytics engine 421 in an effort to identify hidden patterns, unknown correlations and other types of useful information from the collected data to improve the transactional computing network and improve the decision making by the computing systems of network 400. The conclusions drawn by performing the data analytics on the information stored by the SQL engine 411 may allow for the transaction system to prepare and provide business intelligence, using predictive modeling to the improve predictive capabilities of the buyers and merchants registered with the transaction system 405, generate business reports, track buying and selling trends and report these trends to buyers and merchants. In some embodiments, the SQL engine 411, computing cluster engine 413 and/or analytics engine 421 may utilize the data stored and analyzed by the transactional system network 400 to target and deliver merchant advertising through select advertisers 423a, 423b,423c to buyers and display products of the merchants under optimal circumstances to increase the probability of generating a sale.

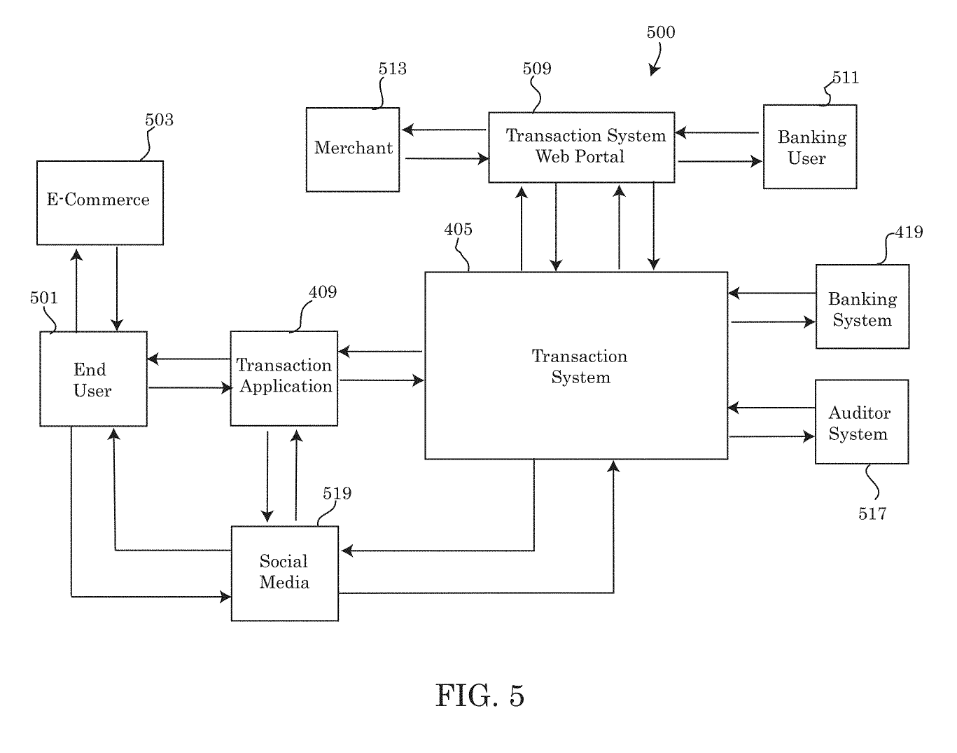

Referring to FIG. 5 depicting a flowchart visually depicting an embodiment of a computing network 500 implementing a secured electronic transaction in accordance with the computing systems, methods and tools described above. In the flowchart depicted in FIG. 5, the exemplary embodiment of the computing network 500 may include a transaction system 405. The transaction system 405 may act as the central computing system or node on the computing network 500. The transaction system 405 may facilitate and act as a medium through which a secured electronic transaction occurs. The transaction system 405 may be a single, central computing system in some embodiments, while in other embodiments, the transaction system 405 may be a plurality of networked computers or a computer cluster sharing and pooling resources, such as processing power, memory, storage space and programs including analytics engines 421, computer cluster engines 413 and SQL engines 411.

The various parties to the secured electronic transaction may connect and communicate with the transaction server, as described in step 305 above using a plurality of methods. As shown in FIG. 5, an end user 501, such as a buyer may connect and communicate with the transactional system 405 using a transaction application 409. As described above, the transaction application 409 may be an application containing program code loaded in the memory of the buyer's computing system or remotely accessible by the buyer's computing system which may contain program instructions and an interface for sending and receiving data to and from the transaction system 405. The data sent and received using the transaction application may include data signaling to transaction system, the buyer's intent to perform a secured electronic transaction, the transmission of the graphical code, the buyer's acceptance of the transaction as described by the graphical code, input, acceptance, transmission and verification of biometric data, and affirmation of the buyer to proceed with closing the secured electronic transaction.

In some embodiments, the use of the transactional application 409 to connect with the transactional system is not merely limited to the end user 501 acting as a buyer. Other computing systems connecting to the transaction system 405 may load and execute instructions to the transaction system via a transactional application 409 to facilitate the electronic transaction. For example, a merchant, or even the bank responsible for verifying and transferring fund may communicate with the transaction system 405 through a transaction application 409 locally stored or remotely accessible on the merchant's computing system or banking computer system 419.

In alternative embodiments, the merchant 513, banking user 511 and/or the end user 501 may connect to the transaction server 405 using the transaction system's web portal 509 or other network based or web based application to remotely connect to the transaction server 405. Other methods for connecting with the transactional system 405 may include a direct communication with the transaction system via a telecommunication network through a standard protocol being mediated by a message broker. In the exemplary embodiment shown in FIG. 5, the banking system responsible for verifying an transferring the funds from the buyer's account to the merchant's account, may through a telecommunications network using the message broker as an intermediary between the transaction system 405 and the banking system 419.

In some embodiments, the transaction network 500 may implement a secure electronic transaction through data provided by the end user 501 using the social media network 519 to further authorize the transaction at step 315 of the method described above, adding an additional layer of security and authorization to complete the transaction. For example, an end user 501 making a purchase from a merchant's ecommerce store 503 using the transaction application 409 may make a purchase request via the application 409. The transactional information may subsequently be provided to the transaction application from the transaction system and displayed in the form of the graphical code on the buyer's social media network or through a private messaging service operated by the social media network 519. Upon receipt of the graphical code on the social media network, the buyer may confirm and accept the transaction through the social media network 519 which may communicate the acceptance by the user back to transaction application 409 or directly to the transaction system 405 and proceed to initiate the steps for authorizing payment of the transaction. Furthermore, not only does the inclusion of social media network for performing the authorization of the transaction integrate an additional layer of security by limiting the role of transaction application to mediate the entire acceptance and confirmation steps 311, 313, 315, 319 (preventing a hacked account from being the sole authority for making purchases) but in addition, the social media networks 519 may be utilized as data streams feeding information buyers and merchants through the buyer and seller's social media networks to the transactional system 405. These data streams from the social media networks may be stored in a SQL engine or other database program and in turn perform data analytics on the information collected from each social media network stream to improve the transaction network's 500's knowledge of buyers and merchants and target merchant advertising to the buyers.

In some embodiments of the transaction network 500 may further include an auditing system 517. The presence of a network auditing system 517 or auditing program. The auditing system may add an additional layer of security to the transaction network by gathering and analyzing network data and network logs with the purpose of ascertaining the health and integrity of the network to ensure that the network is working within a particular set of defined requirements. The auditing system 517 may provide insight to the network administrator regarding the effectiveness of network control policies and the compliance of the network to adhere to internal or external network policies and regulations. The auditing system 517 may verify the integrity of the transaction network by analyzing the network 500 for vulnerabilities, threats, performance, management and availability of the network and then report the vulnerabilities, threats, availability, performance and network security to network administrators. Embodiments of the auditing system 517 may analyze not only the transaction system 405 of the network, but moreover each node of the network, including but not limited to the buyer's computing system, the merchant's computing system, the banking system 419 and even the social media network 519 which may be connected to the transaction server and streaming information to the network 500.

In some embodiments, the auditing functions of the auditing system 517 may be performed by the transaction application 409, instead of a separate and distinct auditing system 517, as shown in the transaction network 600. Moreover, in the alternative embodiment of the transaction network 600, the computing systems of the end user 501, the merchant 513 and the banking user 511 may communicate with the transaction system 409 through the message broker 415 loaded as a program module in one or more nodes connected to the network 600, instead of via the transactional application 409 or a web based application portal or service 509 as illustrated in FIG. 5. However, in some embodiments, the web based portal or web based application or service may still be used for the purpose of registering the buyer and merchant information and acquiring login credentials with the transaction system 405, prior to initiating the secured electronic transaction.

FIG. 7 visually illustrates an exemplary embodiment of a computing network 700 comprising computing systems, methods and tools for implementing the secured electronic transaction, in accordance with the disclosure of the current application as well as data analytics and reporting applications for improving business intelligence for merchants and targeting products to buyers. In particular, the computing network 700 may be an example of a cloud computing network comprised of a plurality of nodes, wherein each node or collection of nodes performs a particular task or may be loaded with a particular program or application in the memory of the node. As shown in FIG. 7, the various nodes of the computing network may include a transaction system 405 acting as a central node of the network 700 and separate computing systems connecting to the network 700 such as the graphic code generator system 403, a bank processing system 419, merchant system 417, web server 407 and transaction system 405.

Embodiments of the transaction system 405 may include a data collection system 707 having a data collection program installed thereon. For example, the data collection system 707 may be a program or platform similar to IBM's InfoSphere™ Streams, capable of capturing important transaction data or other business data of the secured electronic transactions and forwarding the data to the SQL engine 411, for storage in the data warehouse 711 or one or more relational databases 715 or data tables.

In some embodiments, of the computing network 700, one or more social media networks 705a, 705b, 705c may stream the social media data to the data collection system 707 through a message broker 415. The data streamed from the social media networks may be integrated as part of performing the secured electronic transaction. In particular, the data provided may relate to the buyer's acceptance of the transaction in some embodiments. In other embodiments, the stream of data transmitted by the social media networks may provide business intelligence data relating to the buyers and merchants utilizing the transaction network 700 and transaction system 405, as well a data relating to the performance of electronic transactions performed using the computing network 700.

Embodiments of the data streaming from the social media networks may be provided from a separate or different network or operating system than computing network 700. Under such circumstances, the different computing networks or operating systems may facilitate communication between the transaction network 700 and the social media network using an application programming interface (API) 702. For example, not only may each of the social media networks 705a, 705b, 705b be a separate and distinct network from computing network 700, but in some embodiments, other systems previously described may belong to separate networks including the graphic code generator system 403, merchant system 417, web server 407, bank processing system 419 and/or buyer's computing system. In some embodiments, the communications transmitted from the social media networks to the transaction network 700 may be processed and handled using IBM Web Sphere® MQ for message handling and DB2® database access for interfacing with the SQL engine.

Embodiments of the transaction system 405 may a data collection system 707, receiving data streams from each node of the computing network 700, as well as streams of informational data from the one or more social media networks. In addition to the data collection system 707, one or more nodes of the computing network 700 may further include a computing cluster engine 413 such as a Hadoop cluster, an SQL engine 411 and an analytics engine 421. As noted above, functions of the SQL engine 411 may include creating relational databases 715 for processing the electronic transactions and for analytically evaluating electronic transaction data in tandem with the computing cluster engine 413 and analytics engine 421. In some embodiments, the functions of the SQL engine 411 may include creating tables for storing electronic transaction data, buyer and seller information and database objects such as indexes views, and stored procedures for viewing, managing or securing the electronic transaction data and transactional information. The created data tables and database objects of the SQL engine 411 may be stored in a data warehouse 711.

In some embodiments of the transaction system, the analytics engine 421 may be a Netezza analytics cluster which may fuse the data warehousing and in-database analytics into an advanced parallel processing analytic platform capable of processing through large volumes of data on the order of petabytes, allowing for users of the transaction system 405 analyzing the data provided by the transactions and social media networks, to submit sophisticated queries relating to the collected data, perform more accurate predictive analytics and business intelligence.

In some embodiments, the transaction system 405 comprising the SQL engine 411, data analytics engine and/or computing cluster engine may further include a program or module for a lightweight directory access protocol (LDAP) 709 to improve the security and accessibility of the information received and stored by the SQL engine 411. LDAP 709 allows servers and nodes of the computing network to query and filter data stored by the SQL engine 411, allowing for precise retrieval of stored data when transaction system 405 is queried to do so. Embodiments of the LDAP 709 does not define how programs such as the SQL engine, computing cluster engine or analytics engine work, but rather the LDAP 709 may define the language used by each of the programs communicating with the transaction system or nodes on the computing network 700, harmonizing communication of the data from the nodes to the computing programs performing the data analytics. Furthermore, LDAP 709 may further define permissions to access the SQL engine's databases such as the relational database 715 or data warehouse 711 by allowing only certain users to access these databases thus keeping private merchant information, buyer information, payment information and other transaction related information confidential.

A user of the transaction system may gain access to the data analytics and business intelligence information collected by the transaction system 405 by directly accessing the transaction system via one or more applications or programs 720 loaded in the memory of the transaction system 405 or through an application 720 capable of remotely accessing the analytical data stored by the SQL engine 411. For example, in some embodiments, the analytics data may be accessed via computing system accessing a portal 717 hosted by a federation server 719. A computing system having access to the analytics data of the transaction system 405 may do so by signing into the federation serve 717 via the data access portal, providing identifying information or login credentials and then being verified by the data access portal 717 as being authorized to access the analytics information collected by the transaction system 405. The user of the computing system accessing the analytics information may utilize one or more data interpretation applications 720 to run queries as a function of the analytical data, generate reports relating to the collected data and use data visualization 721 software to visually present the analytical data and conclusions drawn by the analytical engine 421.

FIG. 8 illustrates a computer system 890 used for implementing a secure electronic transaction, in accordance with embodiments of the present invention. The computer system 890 comprises a processor 891, an input device 892 coupled to the processor 891, an output device 893 coupled to the processor 891, and memory devices 894 and 895 each coupled to the processor 891. The input device 892 may be, inter alia, a keyboard, a mouse, etc. The output device 893 may be, inter alia, a printer, a plotter, a computer screen, a magnetic tape, a removable hard disk, a floppy disk, etc. The memory devices 894 and 895 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 895 includes a computer code 897 which is a computer program that comprises computer-executable instructions. The computer code 897 includes software or program instructions that may implement an algorithm (e.g. the algorithm of FIG. 3) for performing a secure electronic transaction. The processor 891 executes the computer code 897. The memory device 894 includes input data 896. The input data 896 includes input required by the computer code 897. The output device 893 displays output from the computer code 897. Either or both memory devices 894 and 895 (or one or more additional memory devices not shown in FIG. 8) may be used as a computer usable storage medium (or program storage device) having a computer readable program embodied therein and/or having other data stored therein, wherein the computer readable program comprises the computer code 897. Generally, a computer program product (or, alternatively, an article of manufacture) of the computer system 890 may comprise said computer usable storage medium (or said program storage device).

While FIG. 8 depicts the computer system 890 as a particular configuration of hardware and software, any configuration of hardware and software, as would be known to a person of ordinary skill in the art, may be utilized for the purposes stated supra in conjunction with the particular computer system 890 of FIG. 8. For example, the memory devices 894 and 895 may be portions of a single memory device rather than separate memory devices.

In some embodiments, rather than being stored and accessed from a hard drive, optical disc or other writeable, rewriteable, or removable hardware memory device 895, stored computer program code 897 (e.g., including the algorithm of FIG. 3) may be stored on a static, nonremovable, read-only storage medium such as a Read-Only Memory (ROM) device, or may be accessed by processor 891 directly from such a static, nonremovable, read-only medium. Similarly, in some embodiments, stored computer program code 897 may be stored as computer-readable firmware, or may be accessed by processor 891 directly from such firmware, rather than from a more dynamic or removable hardware data-storage device 895, such as a hard drive or optical disc.

Still yet, any of the components of the present invention could be created, integrated, hosted, maintained, deployed, managed, serviced, etc. by a service supplier who offers to enable a method for implementing a secure electronic transaction. Thus, the present invention discloses a process for deploying, creating, integrating, hosting, maintaining, and/or integrating computing infrastructure, including integrating computer-readable code into the computer system 890, wherein the code in combination with the computer system 890 is capable of performing a method for implementing a secure electronic transaction. In another embodiment, the invention provides a business method that performs the process steps of the invention on a subscription, advertising, and/or fee basis. That is, a service supplier, such as a Solution Integrator, could offer to enable a process of implementing a secure electronic transaction. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for performing a secure electronic transaction, said method comprising the steps of:
requesting, by a computer processor, a connection to an electronic transaction system;
receiving, by the computer processor, a graphical code from the transaction system, comprising transactional information, said transactional information identifies terms of the secure electronic transaction, wherein said transactional information excludes confidential information;
displaying, by the computer processor, the transactional information;
transmitting, by the computer processor, biometric authentication to the transaction system, approving the terms of the secure electronic transaction;
further transmitting, by the computer processor, payment information to the transaction system for satisfying the terms of the secure electronic transaction, wherein the payment information excludes confidential information; and
further receiving, by the computing processor, confirmation of a successful funds transfer from an issuing bank to a merchant account.

2. The method of claim 1, wherein the electronic transaction system is a server of a cloud computing network.

3. The method of claim 1, wherein the graphical code received from the transaction system is selected from the group consisting of ITF codes, Code 93, CODABAR, GS1 DATABAR, MSI Plessey barcodes, 2D barcodes, QR codes, data matrix codes, PDF417 or Aztec barcodes.

4. The method of claim 1, wherein the biometric authentication comprises scanning a fingerprint, scanning a retina, facial recognition or voice recognition.

5. The method of claim 1, wherein the transactional information consists of an invoice identification number including a product identification number, quantity term and a price term and a truncated merchant account identification number.

6. The method of claim 5, wherein the payment information consists of the invoice identification number and a truncated buyer account identification number.

7. The method of claim 1, wherein a buyer closes the secure electronic transaction by performing the step of further transmitting payment information.

8. The method of claim 1, further comprising providing at least one support service for at least one of creating, integrating, hosting, maintaining, and deploying computer-readable program code in a computer system, where the computer-readable program code in combination with the computer system is configured to implement the steps of requesting, receiving, displaying, transmitting, further transmitting, and further receiving.

9. A computer program product, comprising one or more computer readable hardware storage devices having computer readable program code stored therein, said program code containing instructions executable by the one or more computer processors to implement a method for performing a secure electronic transaction, said method comprising the steps of:
requesting, by a computer processor, a connection to an electronic transaction system;
receiving, by the computer processor, a graphical code from the transaction system, comprising transactional information, said transactional information identifies terms of the secure electronic transaction, wherein said transactional information excludes confidential information;
displaying, by the computer processor, the transactional information;
transmitting, by the computer processor, biometric authentication to the transaction system, approving the terms of the secure electronic transaction;
further transmitting, by the computer processor, payment information to the transaction system for satisfying the terms of the secure electronic transaction, wherein the payment information excludes confidential information; and
further receiving, by the computing processor, confirmation of a successful funds transfer from an issuing bank to a merchant account.

10. The computer program product of claim 9, wherein the electronic transaction system is a server of a cloud computing network.

11. The computer program product of claim 9, wherein the graphical code received from the transaction system is selected from the group consisting of ITF codes, Code 93, CODABAR, GS1 DATABAR, MSI Plessey barcodes, 2D barcodes, QR codes, data matrix codes, PDF417 or Aztec barcodes.

12. The method of claim 9, wherein the biometric authentication comprises scanning a fingerprint, scanning a retina, facial recognition or voice recognition.

13. The computer program product of claim 9, wherein the transactional information consists of an invoice identification number including a product identification number, quantity term and a price term and a truncated merchant account identification number.

14. The computer program product of claim 13, wherein the payment information consists of the invoice identification number and a truncated buyer account identification number.

15. A computer system, comprising one or more processors, one or more memories coupled to the one or more computer processors, and one or more computer readable storage devices coupled to the one or more processors, said one or more storage devices containing program code executable by the one or more processors via one or more memories to implement a method for performing a secure transaction, said method comprising the steps of:
requesting, by a computer processor, a connection to an electronic transaction system;
receiving, by the computer processor, a graphical code from the transaction system, comprising transactional information, said transactional information identifies terms of the secure electronic transaction, wherein said transactional information excludes confidential information;
displaying, by the computer processor, the transactional information;
transmitting, by the computer processor, biometric authentication to the transaction system, approving the terms of the secure electronic transaction;
further transmitting, by the computer processor, payment information to the transaction system for satisfying the terms of the secure electronic transaction, wherein the payment information excludes confidential information; and
further receiving, by the computing processor, confirmation of a successful funds transfer from an issuing bank to a merchant account.

16. The computer system of claim 15, wherein the electronic transaction system is a server of a cloud computing network.

17. The computer system of claim 15, wherein the graphical code received from the transaction system is selected from the group consisting of ITF codes, Code 93, CODABAR, GS1 DATABAR, MSI Plessey barcodes, 2D barcodes, QR codes, data matrix codes, PDF417 or Aztec barcodes.

18. The computer system of claim 15, wherein said computing system further comprises biometric sensors receiving the biometric authentication.

19. The computer system of claim 15, wherein the transactional information consists of an invoice identification number including a product identification number, quantity term and a price term and a truncated merchant account identification number.

20. The computer system of claim 19, wherein the payment information consists of the invoice identification number and a truncated buyer account identification number.
